(19) United States
(12) Patent Application Publication
(10) Pub. No.: US 2011/0031718 A1
(43) Pub. Date: Feb. 10, 2011

(54) Trailer Coupling for Motor Vehicles

(75) Inventors: Raffaele Di Parma, Markgroeningen (DE); Axel Krauss, Sindelfingen (DE); Karl Naegele, Bietigheim-Bissingen (DE); Joerg Riehle, Asperg (DE)

Correspondence Address: REINHART BOERNER VAN DEUREN P.C., 2215 PERRYGREEN WAY, ROCKFORD, IL, 61107, US

(73) Assignee: SCAMBIA INDUSTRIAL DEVELOPMENTS AKTIENGESELLSCHAFT, Schaan (LI)

(21) Appl. No.: 12/839,676

(22) Filed: Jul. 20, 2010

(30) Foreign Application Priority Data
Jul. 21, 2009 (DE) 10 2009 035 334.8

(51) Int. Cl. B60D 1/14

(52) U.S. Cl. 280/504

(57) ABSTRACT

In order to improve a trailer coupling for motor vehicles comprising a towing element for the attachment of a vehicle trailer or mounting of a rear load carrier, a cross member, with which a holding unit bearing the towing element is connected, and side members connecting the cross member to a vehicle body at its end areas, in such a manner that it can be produced as simply as possible and so as to save on material as far as possible it is suggested that the cross member comprise a cross member pipe, that the holding unit be held releasably on the cross member, that the holding unit be designed to engage around the cross member in circumferential direction and have at least two holding elements which abut with supporting surfaces on casing surface areas of the cross member pipe and that the holding unit be adapted to be fixed to the cross member by way of a force locking clamping.

### CROSS-REFERENCE TO RELATED PATENT APPLICATIONS

This patent application claims the benefit of German application No. 10 2009 035 334.8, filed Jul. 21, 2009, the teachings and disclosure of which are hereby incorporated in their entirety by reference thereto.

### BACKGROUND OF THE INVENTION

The invention relates to a trailer coupling for motor vehicles, comprising a towing element for attachment of a vehicle trailer or mounting of a rear load carrier, a cross member, with which a holding unit bearing the towing element is connected, and side members connecting the cross member to a vehicle body at its end areas.

Trailer couplings of this type are known from the state of the art, for example, from German patent application 198 57 321 A.

In the case of these trailer couplings, the holding unit is normally welded to the cross member in order to create a secure connection, in particular a connection which takes into account, on the one hand, the constant change of load and the dynamic stresses.

Such a weld connection does, however, have the disadvantage that it is expensive to produce and, on the other hand, requires solid components for the cross member, as well, so that an adequate rigidity and load-bearing capacity of the cross member is present despite the microstructural changes occurring during welding.

The object underlying the invention is, therefore, to improve a trailer coupling of the generic type in such a manner that it can be produced as simply as possible and so as to save on material as far as possible.

### SUMMARY OF THE INVENTION

This object is accomplished in accordance with the invention, in a trailer coupling of the type described at the outset, in that the cross member comprises a cross member pipe, that the holding unit is held releasably on the cross member, that the holding unit is designed to engage around the cross member in circumferential direction and has at least two holding elements which abut with supporting surfaces on casing surface areas of the cross member pipe and that the holding unit can be fixed to the cross member by way of a force locking clamping.

The advantage of the solution according to the invention is to be seen in the fact that with it it is no longer necessary to weld the holding unit to the cross member and, therefore, the resources required for the production of a sufficiently stable weld connection for fixing the holding unit in place are, on the one hand, dispensed with and, on the other hand, the microstructural changes caused by the welding also no longer occur in the cross member and so these microstructural changes need no longer be taken into account for the dimensioning of the cross member and, therefore, a cross member can be used which has a lighter weight.

In order to be able to pass the forces into the cross member in an optimum manner, it is preferably provided for the supporting surfaces of the holding elements to abut on the casing surface of the cross member pipe in circumferential direction altogether over an angular area of more than 200°.

It is even better when the supporting surfaces abut on the casing surface of the cross member pipe in circumferential direction altogether over an angular area of more than 270°.

A sufficiently stable support for the holding unit on the cross member pipe does, therefore, result with these solutions and so all the forces acting on the towing element can, in particular, be passed into the cross member pipe in an optimum manner although no weld connection exists between the holding unit and the cross member pipe.

With respect to the fixing of the holding unit in place on the cross member pipe, the most varied of solutions are conceivable. For example, it would be conceivable to provide connecting elements between the holding elements which penetrate the cross member.

Such a penetration of the cross member does, however, have the disadvantage that the cross member is impaired with respect to its stability.

For this reason, a solution which is particularly advantageous for reasons of stability provides for the holding elements to be connected to one another by connecting elements which extend in a manner free from penetration with respect to the cross member.

These connecting elements therefore extend outside the cross member and merely have the task of fixing the holding elements relative to one another.

The holding elements could, in this respect, be designed in the most varied of ways. For example, all the holding elements can be designed as identical parts.

One advantageous solution provides for the holding unit to have as holding element a base member which has a receptacle for holding the towing element and for at least one holding bracket to be connected to the base member as additional holding element.

An optimum connection of the towing element to the cross member may be achieved, in particular, in a simple manner with such a design of the holding unit.

In this respect, two holding elements would, in principle, be sufficient.

A particularly stable and favorable solution, also with respect to the introduction of loads, provides for two holding brackets, which are arranged at a distance from one another in longitudinal direction of the cross member, to be connected to the base member as holding members.

As a result of the two holding brackets arranged at a distance from one another in longitudinal direction of the cross member, it is possible in a particularly advantageous manner to pass the forces acting on the towing element into the cross member in an optimum manner and also to stabilize the towing element, in particular, in an optimum manner relative to the cross member.

Such an improved introduction of the forces into the cross member also has, in particular, the advantage that the cross member can be produced from a material having less weight, i.e., for example, a thinner wall thickness since the forces acting on the individual respective sites are less.

A connection of such holding brackets to the base member could be brought about in the most varied of ways.

For example, the holding brackets and the base member could be encircled altogether by one or several connecting elements.

One particularly favorable solution provides for the holding brackets to be connected to the base member on oppositely located sides, wherein, for this purpose, connecting elements are used, in particular, which pass through the holding brackets and the base member, i.e., for example, screws.

With respect to the arrangement of the holding elements on the cross member, no further details have so far been given.

For example, it would be conceivable to design the holding elements as holding straps.

One particularly favorable solution provides for the holding elements to be solid members, from which the holding unit is formed.

Particularly in the case of solid members, it is provided for them to be dimensionally stable so that the forces can be transferred to the cross member in an optimum manner with holding elements of this type.

The holding elements designed in accordance with the invention can be arranged relative to one another in the most varied of ways.

One advantageous solution, for example, provides for the holding elements to be arranged on oppositely located sides of a dividing plane.

The dividing plane is preferably aligned such that it extends within an angular area of plus/minus 20° in relation to a horizontal plane in the mounted state of the trailer coupling.

It is even more advantageous when the dividing plane is aligned such that it extends within an angular area of plus/minus 10° in relation to a horizontal plane in the mounted state of the trailer coupling.

An advantageous fixing of the holding elements to the cross member results, in particular, when the holding elements have supporting surfaces which extend at an increasingly large distance from one another with an ever decreasing distance from the dividing plane so that the supporting surfaces extend in the direction of the dividing plane in a widening manner.

Such a widening course can be realized in the most varied of ways.

One simple solution for a widening course of the supporting surfaces would be a wedge-like course. Other courses would be, for example, courses which are like parabolas, semi-circles or semi-ellipses in cross section or also combinations of such courses.

In order to achieve a high rigidity of the connection between the holding unit and the cross member, it is also preferably provided for the holding elements bearing the supporting surfaces to be dimensionally stable so that, as a result, the supporting surfaces also automatically represent surface areas of dimensionally stable members.

In principle, the supporting surfaces could be designed in the most varied of ways.

In order to be able to ensure a secure seating of the supporting surfaces on the casing surface areas of the cross member pipe, it would be conceivable, for example, to design the supporting surfaces as profiled surfaces, i.e., with a surface structure. Such surface structures could be, for example, teeth or projecting ribs or similar structures, wherein these surface structures would then have to be designed, for example, such that they embed themselves in the casing surface area of the cross member pipe in order to provide a secure connection to it.

For reasons of as simple a producibility of the holding elements as possible, it is preferably provided for the supporting surfaces to abut areally on the casing surface areas of the cross member pipe.

Such an areal abutment of the supporting surfaces does not necessarily require an all-over abutment of the supporting surfaces. In this respect, it is, for example, sufficient when the supporting surfaces abut on the casing surface areas all over with more than two thirds of their surface extension.

With respect to the force locking clamping for the purpose of fixing the holding unit in place on the cross member pipe, no further details have so far been given.

One embodiment is conceivable, for example, with which the holding unit abuts on the cross member with the supporting surfaces described and the holding unit is fixed in place, in addition, by way of clamping.

One particularly favorable solution provides for the holding unit to be held on the cross member by clamping elements.

These clamping elements could, for example, be additional clamping elements which engage on the cross member, in particular on the cross member pipe, outside the holding elements or next to the holding elements.

In a solution which is particularly simple it is provided for the holding elements to act as clamping elements so that the holding elements have a double function, namely, on the one hand, to ensure an adequately good support for the holding unit on the cross member in order to introduce forces into the cross member in an optimum manner and, on the other hand, to secure the fixing of the holding unit in place on the cross member.

In this respect, it is provided, for example, for the holding elements to abut on the casing surface areas of the cross member pipe in a clamping manner with at least some of the supporting surfaces.

It is particularly favorable when the holding elements abut on the casing surface areas of the cross member pipe in a clamping manner with all the supporting surfaces.

No further details have so far been given concerning the design of the cross member itself except for the fact that the cross member comprises a cross member pipe.

In order to be able to produce a cross member with a cross member pipe in a simple manner, it is preferably provided for the cross member pipe to be designed to be free of edges in circumferential direction, i.e., for the cross member pipe itself to have no edges extending transversely to the circumferential direction.

It is particularly favorable, in particular, for the stability of the cross member pipe when the cross member pipe has a casing surface which extends in a curved manner in circumferential direction with more than 70% of its circumference. It is even better when the cross member pipe has a casing surface which extends in a curved manner in circumferential direction with more than 80%, even better more than 90% of its circumference.

One particularly expedient solution provides for the cross member pipe to have a casing surface which always extends in a curved manner in circumferential direction, wherein the curvature can be slight, i.e., can decrease to values close to or at zero.

One particularly favorable solution provides for the cross member pipe to be a round pipe.

The term round pipe does not mean in this connection that the cross member pipe must have a circular cross section but rather only that the cross member pipe has a rounded cross section, wherein the roundness can vary.

One solution provides for the cross member pipe to have, for example, a casing surface which varies in circumferential direction with respect to its curvature in circumferential direction.

One particularly simple solution provides for the cross member pipe to have a casing surface which extends in a constantly curved manner in circumferential direction, i.e., to have an essentially circular cross section.

In principle, it would be conceivable to assemble the cross member pipe from several parts.

One particularly favorable solution provides, however, for the cross member pipe to be a one-piece part.

For reasons of cost, it is even more advantageous when the cross member pipe is a part produced in one piece.

With respect to the design of the casing surface of the cross member pipe, the most varied of possibilities are conceivable. The cross member pipe can, in principle, have the most varied of geometries. In order to be able to mount the holding unit with the holding elements advantageously, it has proven to be expedient when the cross member pipe has a cylindrical casing surface in the area of the holding element, wherein a cylindrical casing surface does not necessarily mean a circular cylindrical casing surface but rather includes any type of cross sectional shape, as long as this is constant in the area of the holding unit.

One particularly expedient solution provides for the cross member pipe to have a cylindrical casing surface over its entire length.

In order to be able to produce the cross member in a simple manner, it is preferably provided for the cross member pipe to be free from members which are arranged on its casing surface and are connected to it.

Members of this type could be, for example, attached fixing elements or attached stabilizing elements, wherein these members are normally welded to the cross member pipe.

In order to be able to align the holding unit, in particular, in a definitive manner relative to the cross member, in particular relative to the cross member pipe, it is preferably provided for the cross member pipe to be provided with a receptacle for a form locking element of the holding unit, this receptacle being designed to be set back in relation to the casing surface.

This is a particularly simple type of non-rotatable, form locking connection between the holding unit and the cross member pipe which is of advantage, in particular, when the cross member pipe has an essentially circular cross section and, therefore, a precise alignment of the holding unit during its assembly on the cross member pipe is complicated to realize.

A particularly favorable realization of such a form locking connection provides for the cross member pipe to have at least one opening for accommodating a form locking element of the holding unit.

Alternatively thereto, it is conceivable for the cross member pipe to have a recess for accommodating the form locking element of the holding unit.

In conjunction with the preceding description of the individual embodiments, details have merely been given for the connection between the holding unit and the cross member, in particular the cross member pipe.

No explanations have been given in conjunction with the solutions described thus far as to how the connection between the cross member, in particular the cross member pipe, and the side members is intended to be realized.

One particularly favorable solution provides for the side members to engage on the cross member with releasable side member holding units at the ends of the cross member.

As a result, the possibility is likewise given of avoiding additional welding in the end areas of the cross member and, in this respect, of realizing a comparatively simple connection between the cross member and the side members.

This side member holding unit could be designed in the most varied of ways.

For example, it would be conceivable to design the side member holding unit such that this engages in the cross member pipe at its ends and is connected to the cross member pipe by way of joining or by way of form locking elements.

Another advantageous solution provides for the side member holding unit to have at least two releasably connectable side member holding elements which abut on casing surface areas of the cross member pipe with receiving surfaces.

As a result, a possibility for a connection between the cross member and the side members is created which may be designed in a similar way to the connection between the holding elements and the cross member pipe.

For example, it is therefore provided for the receiving surfaces of the side member holding elements to abut on the casing surface of the cross member pipe in circumferential direction altogether over an angular area of more than 200°.

It is even better when the receiving surfaces abut on the casing surface of the cross member pipe in circumferential direction altogether over an angular area of more than 270°.

Furthermore, it is preferably provided for the side member holding unit to be designed to engage around the cross member in circumferential direction with the side member holding elements.

Such an engagement in circumferential direction may be realized particularly favorably when the side member holding elements are connected to one another by connecting elements which extend in a manner free from penetration with respect to the cross member.

This solution has the advantage that, with it, the flow of force extends around the cross member and, therefore, penetrations of the cross member which would weaken the same can be avoided.

Altogether, the side member holding unit can be designed in the most varied of ways.

One expedient solution provides for the side member holding unit to have a base member, which is arranged on the respective side member, as a side member holding element and for at least one additional holding element to be connected to the base member.

This additional holding element could be, for example, a clamping element.

One particularly favorable solution provides for this holding element to be a holding member.

In this respect, the holding members are preferably connected to the base member via connecting elements on oppositely located sides.

The side member holding elements are expediently arranged on oppositely located sides of a dividing plane in the case of the side member holding unit.

In this case, the dividing plane is, however, preferably aligned such that it extends within an angular area of between 50° and 10° in relation to a horizontal plane in the mounted state of the trailer coupling since, as a result, the mounting of the cross member on the side member holding units can be made easier in a simple manner.

It is even more advantageous when the dividing plane is aligned such that it extends within an angular area of 40° to 20° in relation to a horizontal plane in the mounted state of the trailer coupling.

It is favorable, also in the case of the side member holding units, when the side member holding elements have receiving surfaces which extend at an increasingly larger distance from one another with an ever decreasing distance from the dividing plane in order to create the possibility of the receiving surfaces abutting on the casing surface areas of the cross member pipe in an optimum manner.

With respect to the securing of the side member holding unit on the cross member, no further details have so far been given. For example, an additional form locking securing or a securing via clamping could be brought about.

It is particularly favorable when the side member holding unit can be fixed in place on the cross member by way of clamping elements.

This may be realized in a particularly favorable manner when the side member holding elements act as clamping elements.

For example, it is provided in this respect for the side member holding elements to abut on the casing surface areas of the cross member pipe in a clamping manner with at least some of the receiving surfaces.

It is particularly favorable when the side member holding elements abut on the casing surface areas of the cross member pipe in a clamping manner with all the receiving surfaces.

With respect to the abutment of the receiving surfaces on the casing surface areas of the cross member pipe, it is conceivable, for example, to likewise design the receiving surfaces in a profiled manner, i.e., either with teeth or ribs.

One particularly favorable solution provides, however, for the receiving surfaces to abut areally on the casing surface areas of the cross member pipe.

In this respect, it is favorable, in particular, when the receiving surfaces abut on the casing surface areas all over with more than two thirds of their surface extension.

Additional features and advantages of the invention are the subject matter of the following description as well as the drawings illustrating several embodiments.

### BRIEF DESCRIPTION OF THE DRAWINGS

FIG. 1 shows a perspective view of a first embodiment of a trailer coupling according to the invention;

FIG. 2 shows a plan view in the direction of arrow A in FIG. 1;

FIG. 3 shows a view in the direction of arrow B in FIG. 2;

FIG. 4 shows a section along line 4-4 in FIG. 3;

FIG. 5 shows a section along line 5-5 in FIG. 3;

FIG. 6 shows a section similar to FIG. 4 through a second embodiment of a trailer coupling according to the invention;

FIG. 7 shows a section similar to FIG. 4 through a third embodiment of a trailer coupling according to the invention;

FIG. 8 shows a section along line 8-8 in FIG. 2 but in a fourth embodiment of a trailer coupling according to the invention;

FIG. 9 shows a section similar to FIG. 5 in a fifth embodiment of a trailer coupling according to the invention and

FIG. 10 shows a section similar to FIG. 8 in a sixth embodiment of a trailer coupling according to the invention.

### DETAILED DESCRIPTION OF THE INVENTION

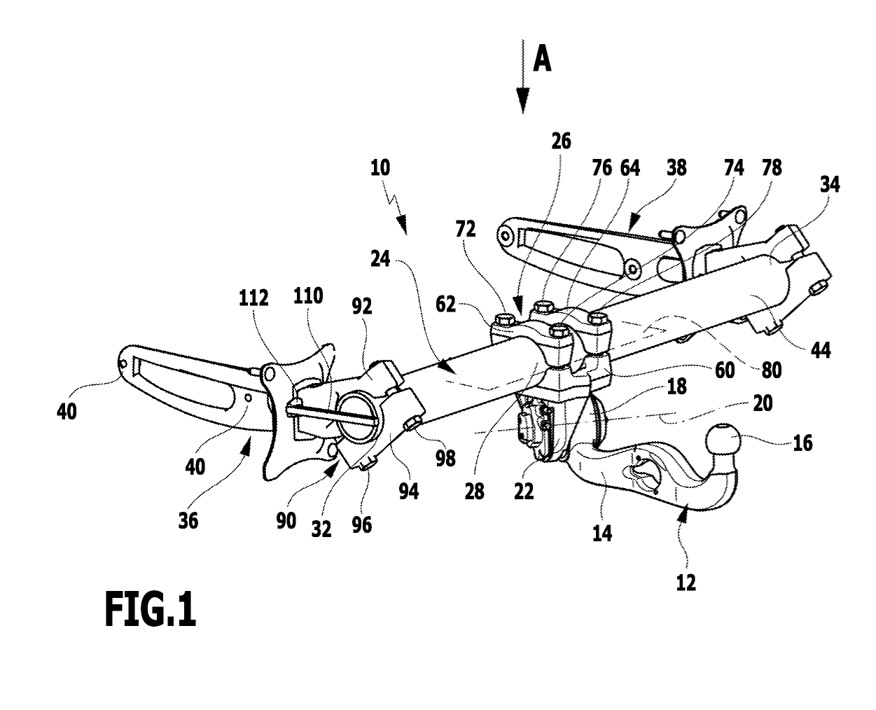

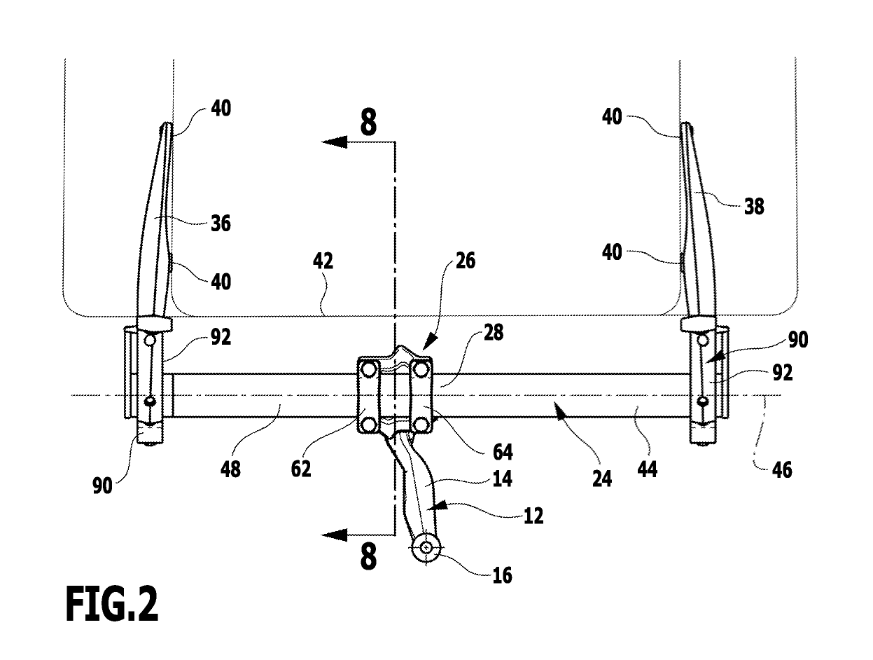

A first embodiment of a trailer coupling 10 according to the invention, illustrated in FIGS. 1 to 5, comprises a towing element 12 which comprises a ball neck 14 as well as a coupling ball 16 at one end of the ball neck 14 as well as a bearing part 18 at the other end of the ball neck 14, wherein the bearing part 18 is mounted, for example, on a bearing unit designated as a whole as 22 so as to be pivotable about a pivot axis 20.

The bearing unit 22 is, for its part, held on a cross member, which is designated as a whole as 24, by means of a holding unit 26, which is designed as a clamping unit, at a central area 28 of the cross member 24 and the cross member 24 is held at its end areas 32 and 34 on side members 36 and 38 which can, for their part, be connected to a body of a motor vehicle, wherein the side members 36 and 38 have assembly points 40 which can be connected to the respective bodywork 42 of the motor vehicle.

As illustrated in FIGS. 1, 4 and 5, the cross member 24 is formed by a cross member pipe 44 which extends along a pipe axis 46 and, in the embodiment illustrated in FIGS. 1 to 5, has an outer casing surface 48 which extends in a circular cylindrical manner in relation to the pipe axis 46 as well as an inner surface 50 which extends in a circular cylindrical manner in relation to the pipe axis 46 and so a pipe wall 52 has an essentially constant thickness in a radial direction in relation to the pipe axis 46.

In this first embodiment, the cross member pipe 44 is preferably designed as a pipe produced in one piece, the outer casing surface 48 of which is free from projections of form locking members placed on it.

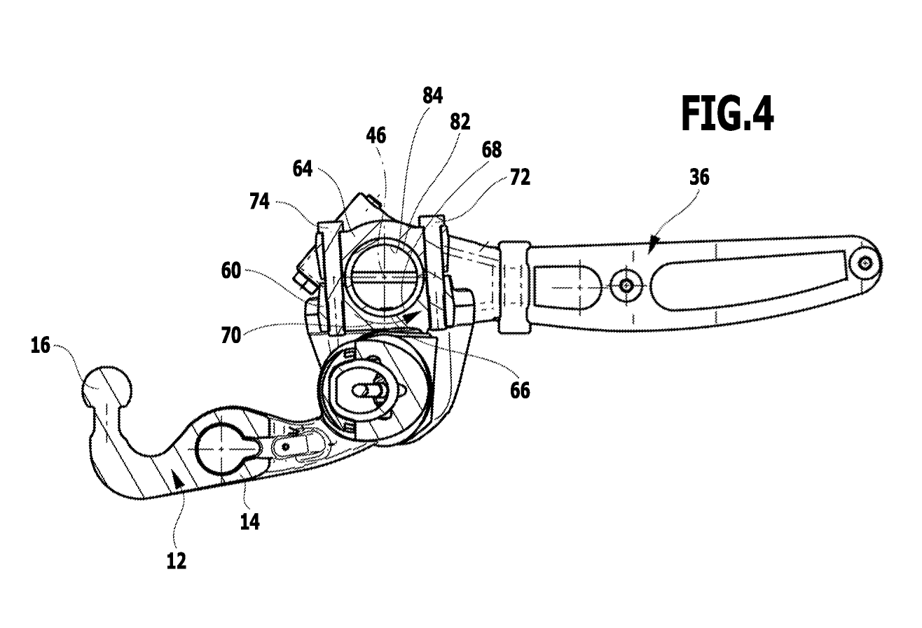

The holding unit 26 arranged in the central area 28 engages around the cross member 24 as well as the cross member pipe 44, as illustrated, for example, in FIGS. 1 and 4, and is, for this purpose, provided with holding elements 60, 62 and 64, wherein the holding element 60 forms a base member which abuts areally with a supporting surface 68 on a casing surface area 66 of the casing surface 48 facing the road, wherein the supporting surface 68 abuts areally on the casing surface area 66 over an angular area of more than 130° in a circumferential direction 70 in relation to the pipe axis 46.

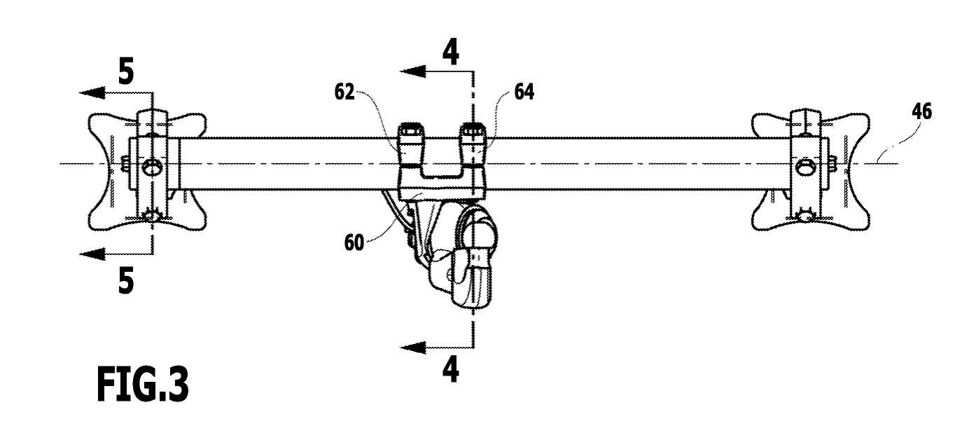

Holding elements designed as holding brackets 62, 64 can be connected to this base member 60 which forms the one holding element, wherein the two holding brackets 62 and 64, as illustrated, for example, in FIGS. 1 and 3, are arranged at a distance from one another in the direction of the pipe axis 46 and each of these holding brackets 62 and 64 can be connected to the base member 60 at their respective ends with connecting elements 72 and 74 or 76 and 78, wherein the connecting elements 72, 74 and 76, 78 are designed, in the simplest case, as screws.

In this respect, the holding brackets 62 and 64 as well as the base member 60 are preferably designed such that the holding brackets 62 and 64 are located on one side of a dividing plane 80, preferably on a side of the dividing plane 80 facing away from the road, while the base member 60 is located on an oppositely located side of the dividing plane 80, in particular on a side of the dividing plane 80 facing the road.

The dividing plane preferably extends parallel to a horizontal plane or is inclined relative to the horizontal plane by at the most plus/minus 20°.

The holding brackets 62 and 64 also abut areally, for their part, on a casing surface area 82 of the casing surface 48 with supporting surfaces 84, wherein the supporting surfaces 84 likewise extend over an angle of at least 130° in the circumferential direction 70 in relation to the pipe axis 46.

In the embodiment illustrated in FIGS. 1 to 5, the connecting elements 72 and 74 as well as 76 and 78 for connecting the holding brackets 62 and 64, respectively, to the base member 60 are designed as clamping screws and therefore allow the supporting surfaces 84 and 68 to abut on the casing surface areas 66 and 82, respectively, of the cross member pipe 44, each acted upon with a clamping force directed transversely to the casing surface areas 66 and 82, respectively, and to be clamped against them so that, altogether, the supporting surfaces 68 and 84, respectively, abut on the casing surface areas 66 and 82 in a force locking, clamping manner and, therefore, fix the entire holding unit 26 in place immovably relative to the cross member pipe 44.

The supporting surfaces 68 and 84 are, in the simplest case, designed as smooth surfaces; it is, however, also conceivable to provide the supporting surfaces 68 and 84 with a profile, i.e., projecting profiled elements, wherein the projecting profiled elements then dig at least partially into the casing surface areas 66 and 82, respectively, wherein the supporting surfaces 68 and 84 abut on them, acted upon with a clamping force acting transversely to the casing surface areas 66 and 82.

In order to achieve a connection between the holding unit 26 and the cross member 24 which does, on the one hand, save on material and is, on the other hand, as stable as possible, the entire holding unit 26 is preferably designed such that the connecting elements 72 and 74 or 76 and 78 extend between the holding elements 60 as well as 62 and 64 without penetration with respect to the cross member 24, in particular to the cross member pipe 44, so that the holding unit 26 engages around the cross member 24 and the cross member pipe 44 on all sides.

In the first embodiment, the holding unit 26 is, therefore, preferably fixed to the cross member pipe 44 without clearance and exclusively in a force locking manner by the supporting surfaces 68 and 84 abutting on the casing surface areas 66 and 82, respectively, and is in a position to absorb all the forces acting on the towing element 12.

The cross member 24 is preferably fixed to the side members 36 and 38 by side member holding units 90 provided on the side members 36 and 38, wherein each of the side member holding units 90 has two side member holding elements 92 and 94, wherein the side member holding element 92 is securely connected to the respective side member 36 or 38 and forms a base member while the side member holding element 94 forms a holding member 94 which can be releasably connected to the base member 92 and can be connected to the base member 92, in particular, by connecting elements 96 and 98. In this respect, the connecting elements 96 and 98 are designed, in the simplest case, as screws.

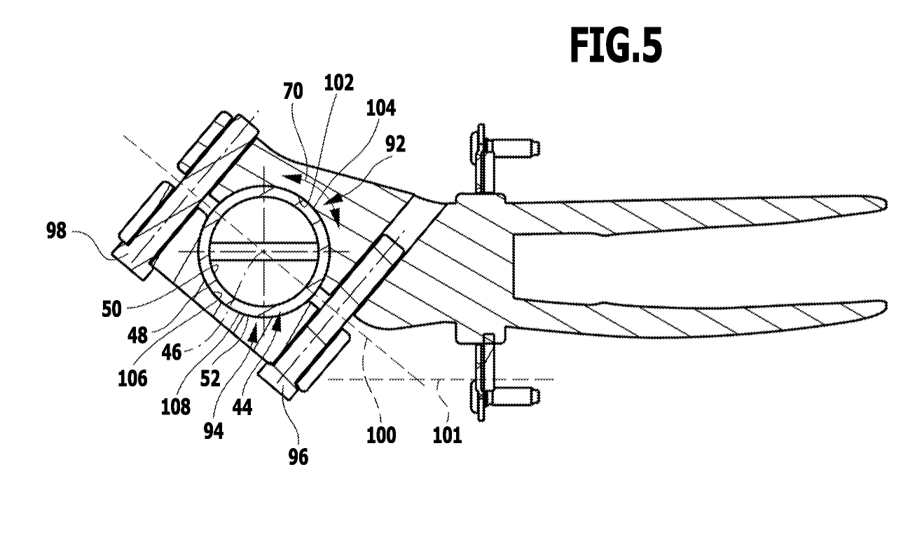

As illustrated, in particular, in FIG. 5, the respective base member 92 abuts with a contact surface 102 on a casing surface area 104 of the cross member pipe 44, wherein the casing surface area 104 is located in the end area 32 or 34 of the cross member pipe 44, wherein the contact surface 102 extends over an angular area of at least 130° in circumferential direction 70 of the cross member pipe 44 with respect to the pipe axis 46.

The holding member 94 also abuts areally on a casing surface area 108 of the cross member pipe 44 with a contact surface 106, wherein the contact surface 106 also extends over an angular area of at least 130° in the circumferential direction 70 with respect to the pipe axis 46.

The base member 92 and the holding member 94 are separated by a dividing plane 100 which extends relative to a horizontal plane 101 at an inclined angle of between 10° and 60°.

The contact surfaces 102 and 106 are therefore in a position to carry and support the cross member pipe 44.

The base member 92 and the holding member 94 can preferably be tensioned towards one another by the connecting elements 96 and 98 such that the contact surfaces 102 and 104 abut on the casing surface areas 104 and 108 in a clamping manner acted upon by force and, therefore, grip the cross member pipe 44 between them in a clamping manner in the end areas 32 and 34 in order to fix it relative to the side members 36 and 38 so as to be non-rotatable and immovable in the direction of the pipe axis 46.

The side member holding units 90 are also each designed such that the connecting elements 96, 98 extend free from penetration with respect to the cross member 24, in particular the cross member pipe 44, as well, and, therefore, engage around the cross member 24, in particular the cross member pipe 44, with a force locking which extends free from penetration around the cross member 24, in particular the cross member pipe 44.

In order to achieve a defined alignment of the cross member 24, in particular the cross member pipe 44, aligning elements 110 are preferably provided on the cross member 24, in particular the cross member pipe 44, and these aligning elements interact with aligning elements 112 which are provided on the side parts 36 and 38 in order to bring about a defined alignment of the cross member 24, in particular the cross member pipe 44, relative to the side parts 36 and 38, respectively, and, therefore, to make the mounting of the cross member 24, in particular the cross member pipe 44, easier relative to the side parts 36 and 38, respectively.

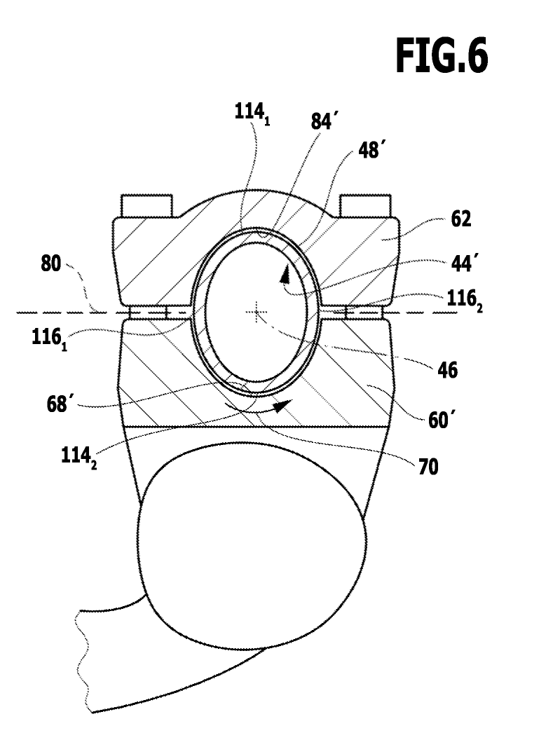

In a second embodiment, illustrated in FIG. 6, the cross member pipe 44′ is not designed as a cross member pipe with a circular cylindrical cross section but rather with an oval cross section so that the casing surface 48′ has a varying curvature in the circumferential direction 70.

The supporting surface 68′ of the base member 60′ is also adapted to this varying curvature of the casing surface 48′ in accordance with the design of the casing surface 48′ and, in the same way, the supporting surface 84′ of the respective holding bracket, in this case the holding bracket 62, is also adapted to the casing surface 48′.

The contact surfaces 102 and 106 of the respective side member holding unit 90 are likewise adapted to the shape of the casing surface 48′ in the same way in this embodiment and so, altogether, the contact surfaces 102 and 106 likewise abut areally on the casing surface 48′.

In the second embodiment, the casing surface 48′ therefore has two areas 114₁ and 114₂ with an increased curvature which are located on opposite sides of the dividing plane 80 as well as, between them, areas 116₁ and 116₂, respectively, with less of a curvature which are located between the areas 114 with an increased curvature.

As a result, the casing surface 48′ widens increasingly with an ever decreasing distance from the dividing surface 80 and so it is thus possible for the supporting surfaces 84′ and 68′ to abut areally on the casing surface 48′.

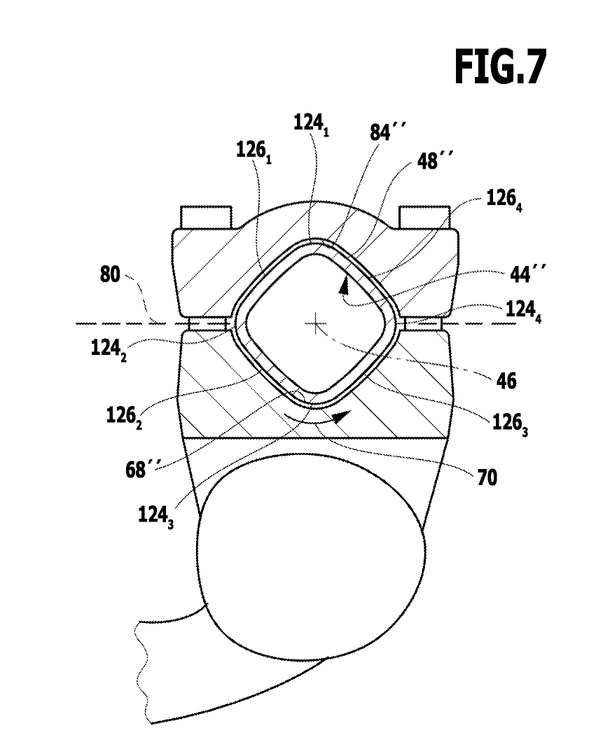

In a third embodiment, illustrated in FIG. 7, the cross member pipe 44″ is designed such that it has, for example, in the circumferential direction 70 four areas 124₁, 124₂, 124₃ and 124₄ with an increased curvature and between them areas 126₁, 126₂, 126₃ and 126₄ with less of a curvature which can be reduced as far as a curvature of zero.

The cross member pipe 44″ is then arranged relative to the dividing plane 80 such that two of the areas 124 with an increased curvature are located on opposite sides of the dividing plane 80 and the dividing plane 80 preferably intersects two of the areas 124 with an increased curvature. As a result, two respective areas 126 with less of a curvature are then located, for example, on respectively opposite sides of the dividing plane 80.

In this case, as well, an advantageous areal abutment of the supporting surfaces 68″ and 84″ on the casing surface 48″ can be achieved since the casing surface 48″ widens with an ever decreasing distance from the dividing plane 80.

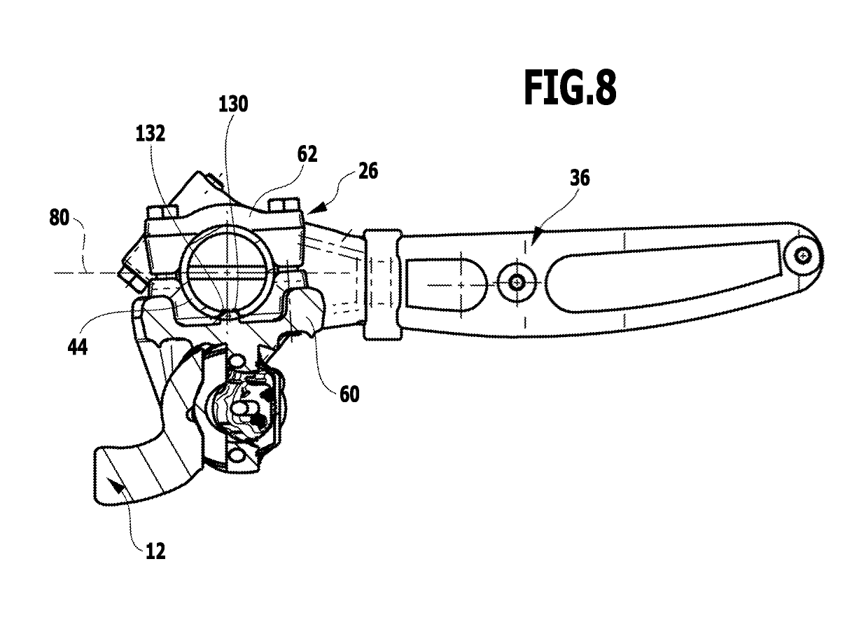

In a fourth embodiment of the trailer coupling, illustrated in FIG. 8, the holding unit 26 is designed in the same way as in the first embodiment and so with respect to the description of the individual parts thereof reference can be made in full to the explanations concerning the first embodiment.

However, in this embodiment the base member 60 is provided with a continuation 130 which can be brought into engagement with a recess 132 in the cross member pipe 44 in order to bring about a defined alignment of the base member relative to the cross member pipe 44.

In this respect, a force locking clamping connection still results between the base member 60, the holding brackets 62 and 64 and the cross member pipe 44 and this essentially transfers the forces which act on the towing element 12 to the cross member pipe so that the continuation 130 represents an additional device for securing against rotation for the alignment of the base member 60 and, therefore, the alignment of the entire holding unit 26 relative to the cross member pipe.

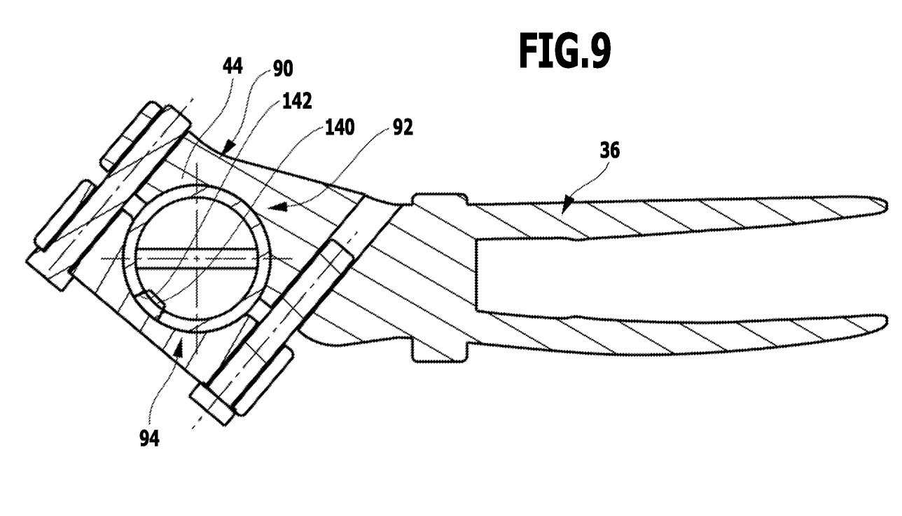

In a fifth embodiment of the trailer coupling according to the invention, illustrated in FIG. 9, the side member holding unit 90 is likewise designed in the same way as in the first embodiment, likewise only with the single difference that, in this case, the holding member 94 is provided with a continuation 140 which engages in a recess 142 in the cross member pipe 44 and, therefore, likewise represents a device for securing against rotation of the cross member pipe 44 relative to the respective side member unit 90.

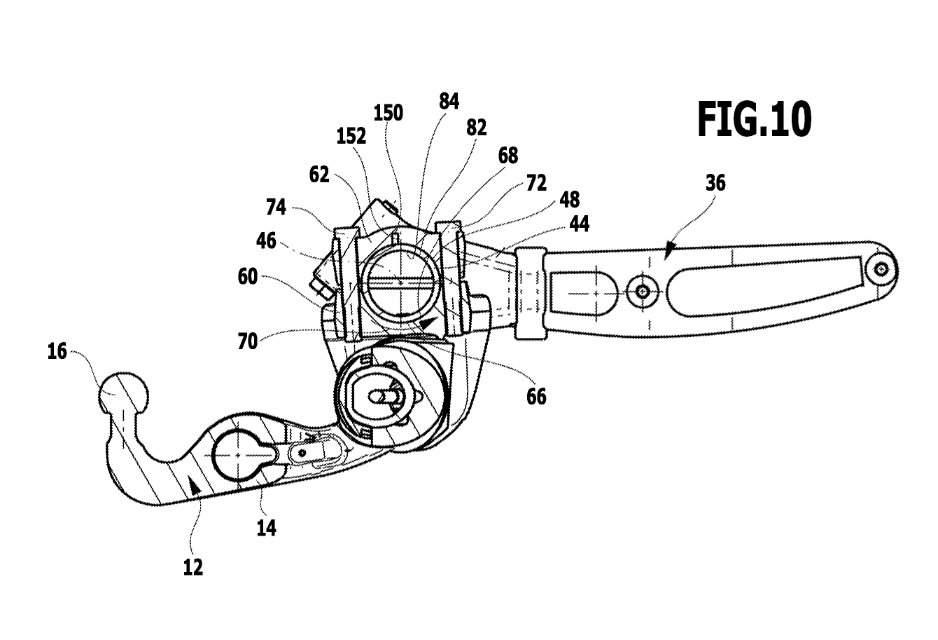

In a sixth embodiment of a trailer coupling according to the invention, illustrated in FIG. 10, the cross member pipe 44 is provided with a form locking member 150 which projects radially beyond the casing surface 48 and engages in a form locking receptacle 152 which is provided in one or both of the holding brackets 62, 64 so that the form locking member 150 and the form locking receptacle 152 likewise determine an alignment of the holding unit 26 relative to the cross member pipe 44.

The form locking member 150 is, for example, designed as a part which is welded on and is preferably seated either on a side of the casing surface 48 facing the road or a side of the casing surface 48 facing away from the road since a part welded onto this area of the casing surface 48 does not result in any impairment whatsoever of the rigidity and stability of the cross member pipe 44.

1. Trailer coupling for motor vehicles, comprising a towing element for the attachment of a vehicle trailer or mounting of a rear load carrier, a cross member, a holding unit bearing the towing element being connected to said cross member, and side members connecting the cross member to a vehicle body at its end areas,
wherein the cross member comprises a cross member pipe, the holding unit being held releasably on the cross member, the holding unit being designed to engage around the cross member in circumferential direction and having at least two holding elements abutting with supporting surfaces on casing surface areas of the cross member pipe, and wherein the holding unit is adapted to be fixed to the cross member by way of a force locking clamping.

2. Trailer coupling as defined in claim 1, wherein the supporting surfaces of the holding elements abut on the casing surface of the cross member pipe in circumferential direction altogether over an angular area of more than 200°.

3. Trailer coupling as defined in claim 2, wherein the supporting surfaces abut on the casing surface of the cross member pipe in circumferential direction altogether over an angular area of more than 270°.

4. Trailer coupling as defined in claim 1, wherein the holding elements are connected to one another by connecting elements extending in a manner free from penetration with respect to the cross member.

5. Trailer coupling as defined in claim 1, wherein the holding unit has as holding element a base member supporting a bearing unit holding the towing element and wherein at least one holding bracket is connected to the base member as additional holding element.

6. Trailer coupling as defined in claim 5, wherein two holding brackets are connected to the base member as holding members, said brackets being arranged at a distance from one another in longitudinal direction of the cross member.

7. Trailer coupling as defined in claim 5, wherein the holding bracket is connected to the base member on oppositely located sides.

8. Trailer coupling as defined in claim 1, wherein the holding elements are arranged on oppositely located sides of a dividing plane.

9. Trailer coupling as defined in claim 8, wherein the dividing plane is aligned such that it extends within an angular area of plus/minus 20° in relation to a horizontal plane in the mounted state of the trailer coupling.

10. Trailer coupling as defined in claim 9, wherein the dividing plane is aligned such that it extends within an angular area of plus/minus 10° in relation to a horizontal plane in the mounted state of the trailer coupling.

11. Trailer coupling as defined in claim 1, wherein the holding elements have supporting surfaces extending at an increasingly larger distance from one another with an ever decreasing distance from the dividing plane.

12. Trailer coupling as defined in claim 1, wherein the holding elements bearing the supporting surfaces are dimensionally stable.

13. Trailer coupling as defined in claim 1, wherein the supporting surfaces abut areally on the casing surface areas of the cross member pipe.

14. Trailer coupling as defined in claim 13, wherein the supporting surfaces abut on the casing surface areas all over with more than two thirds of their surface extension.

15. Trailer coupling as defined in claim 1, wherein the holding unit is adapted to be fixed in place on the cross member by clamping elements.

16. Trailer coupling as defined in claim 15, wherein the holding elements act as clamping elements.

17. Trailer coupling as defined in claim 16, wherein the holding elements abut on the casing surface areas of the cross member pipe in a clamping manner with at least some of the supporting surfaces.

18. Trailer coupling as defined in claim 17, wherein the holding elements abut on the casing surface areas of the cross member pipe in a clamping manner with all the supporting surfaces.

19. Trailer coupling as defined in claim 1, wherein the cross member pipe is designed to be free of edges in circumferential direction.

20. Trailer coupling as defined in claim 1, wherein the cross member pipe has a casing surface extending in a curved manner in circumferential direction with more than 70% of its circumference.

21. Trailer coupling as defined in claim 1, wherein the cross member pipe has a casing surface always extending in a curved manner in circumferential direction.

22. Trailer coupling as defined in claim 1, wherein the cross member pipe is a round pipe.

23. Trailer coupling as defined in claim 1, wherein the cross member pipe has a casing surface varying in circumferential direction with respect to its curvature in circumferential direction.

24. Trailer coupling as defined in claim 1, wherein the cross member pipe has a casing surface constantly curved in circumferential direction.

25. Trailer coupling as defined in claim 1, wherein the cross member pipe has a cylindrical casing surface in the area of the holding unit.

26. Trailer coupling as defined in claim 1, wherein the cross member pipe is a one-piece part.

27. Trailer coupling as defined in claim 1, wherein the cross member pipe is provided with a receptacle for a form locking element of the holding unit, said receptacle being designed to be set back in relation to the casing surface.

28. Trailer coupling as defined in claim 27, wherein the cross member pipe has at least one opening for accommodating a form locking element of the holding unit.

29. Trailer coupling as defined in claim 1, wherein the side members engage on the cross member with releasable side member holding units at the ends of the cross member.

30. Trailer coupling as defined in claim 29, wherein each of the side member holding units has at least two releasably connectable side member holding elements abutting on casing surface areas of the cross member pipe with receiving surfaces.

31. Trailer coupling as defined in claim 30, wherein the receiving surfaces of the side member holding elements abut on the casing surface of the cross member pipe in circumferential direction altogether over an angular area of more than 200°.

32. Trailer coupling as defined in claim 30, wherein the side member holding unit has as a side member holding element a base member connected to the respective side member and wherein at least one holding member is connected to the base member as additional side member holding element.
